(19) United States
(12) Patent Application Publication
(10) Pub. No.: US 2020/0233655 A1
(43) Pub. Date: Jul. 23, 2020

(54) SOFTWARE DISTRIBUTION SYSTEM AND SOFTWARE DISTRIBUTION METHOD

(71) Applicant: TOYOTA JIDOSHA KABUSHIKI KAISHA, Toyota-shi (JP)

(72) Inventors: Atsushi WATANABE, Nisshin-shi (JP); Takashi AGARI, Toyota-shi (JP); Youichi SUZUKI, Toyota-shi (JP); Kentaro KAWANO, Toyota-shi (JP); Ryosuke MORI, Toyota-shi (JP)

(73) Assignee: TOYOTA JIDOSHA KABUSHIKI KAISHA, Toyota-shi (JP)

(21) Appl. No.: 16/713,098

(22) Filed: Dec. 13, 2019

(30) Foreign Application Priority Data
Jan. 23, 2019 (JP) 2019-009570

(51) Int. Cl. G06F 8/65; G06F 11/07; H04L 29/08

(52) U.S. Cl. CPC G06F 8/65; H04L 67/12; G06F 11/0739

(57) ABSTRACT

A software distribution system includes an acquiring unit configured to acquire, from vehicles, error information about an in-vehicle software component having an error; a holding unit configured to hold acquired error information in association with vehicle information of the vehicle from which the error information is acquired; an identifying unit configured to identify an information element common to a plurality of pieces of vehicle information associated with the same error information; and a distribution unit configured to distribute a correction file for correcting the error in the in-vehicle software component to a vehicle group having the identified information element.

### INCORPORATION BY REFERENCE

The disclosure of Japanese Patent Application No. 2019-009570 filed on Jan. 23, 2019 including the specification, drawings and abstract is incorporated herein by reference in its entirety.

### BACKGROUND

### 1. Technical Field

The disclosure relates to a software distribution system and a software distribution method that distribute a correction file for correcting an error in an in-vehicle software component.

### 2. Description of Related Art

Japanese Unexamined Patent Application Publication No. 2018-132979 (JP 2018-132979 A) describes a software update system that remotely updates the software components of in-vehicle devices. A telematics center of the software update system includes an update software distribution unit that distributes update software components for updating the software components of electronic control units (ECUs) to a software update device of each vehicle, and an update item management unit that sets priorities for updates of the software components of the ECUs based on the degrees of importance of the functions of the ECUs and that manages update software components that the update software distribution unit distributes based on the set priorities.

### SUMMARY

In the technique described in JP 2018-132979 A, update software components are distributed to each vehicle sequentially based on the priorities; however, cost increases if the update software components are distributed to all the vehicles.

The disclosure provides a technique for distributing a correction file for correcting an error in an in-vehicle software component at low cost.

An aspect of the disclosure relates to a software distribution system. The software distribution system includes an acquiring unit configured to acquire, from vehicles, error information about an in-vehicle software component having an error; a holding unit configured to hold acquired error information in association with vehicle information of the vehicle from which the error information is acquired; an identifying unit configured to identify an information element common to a plurality of pieces of vehicle information associated with the same error information; and a distribution unit configured to distribute a correction file for correcting the error in the in-vehicle software component to a vehicle group having the identified information element.

Another aspect of the disclosure relates to a software distribution method. The method includes a step of acquiring, from vehicles, error information about an in-vehicle software component having an error; a step of holding acquired error information in association with vehicle information of the vehicle from which the error information is acquired; a step of identifying an information element common to a plurality of pieces of vehicle information associated with the same error information; and a step of distributing a correction file for correcting the error in the in-vehicle software component to a vehicle group having the identified information element.

According to the disclosure, a technique for distributing a correction file for correcting an error in an in-vehicle software component at low cost can be provided.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram for illustrating the configuration of a software distribution system;

FIG. 2 is a diagram for illustrating the functional configuration of the software distribution system;

FIG. 3 is a view that shows information that is held in a holding unit; and

FIG. 4 is a flowchart of a software distribution process.

### DETAILED DESCRIPTION OF EMBODIMENTS

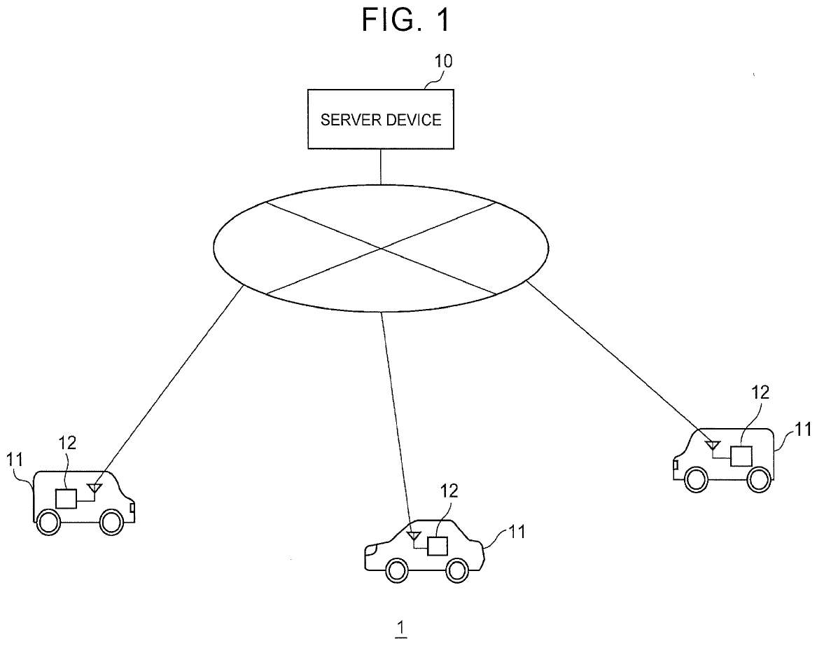

FIG. 1 is a diagram for illustrating the configuration of a software distribution system 1. The software distribution system 1 includes a server device 10 and a plurality of in-vehicle terminal devices 12 connected to the server device 10 via a network.

The in-vehicle terminal device 12 mounted on each of vehicles 11 periodically sends information about a travel environment to the server device 10 and, when the in-vehicle terminal device 12 has detected an error in an in-vehicle software component, sends error information to the server device 10. When there occurs an error in an in-vehicle software component, the in-vehicle terminal device 12 may send error information and travel environment information together. Examples of error information may include vehicle diagnosis information and debug information. Debug information indicates freeze of an in-vehicle software component for screen display or another function, or no sound.

Vehicle information contains a plurality of information elements, such as information on electronic control devices mounted on a vehicle and information about a travel environment of the vehicle when there occurs an error. In-vehicle software components are installed on the electronic control devices mounted on a vehicle. The in-vehicle software components implement various functions, such as a multimedia device, an in-vehicle sensor device, an air conditioner, a central control unit, and an electronic toll collection system (ETC) device. In-vehicle software modules that implement various functions, such as radio, audio, camera, ETC, beacon, telephone, wireless LAN, navigation function, voice recognition function, global positioning system (GPS), and touch panel. Information on each electronic control device contains version information of the installed in-vehicle software component and product information, such as manufacturer information.

Information that indicates a travel environment of a vehicle contains positional information of the vehicle, outside air temperature information, and other information. Positional information of a vehicle may be information indicated by latitude and longitude and/or a road link ID that indicates a road on which the vehicle is traveling. The in-vehicle terminal device 12 sends vehicle information and error information with a vehicle ID attached to the vehicle information and the error information.

The server device 10 acquires travel environment information of vehicle information from the plurality of in-vehicle terminal devices 12 at predetermined intervals, acquires error information together with the travel environment information when an error has been detected, and holds the vehicle information and the error information in association with each other. The timing of sending vehicle information and the timing of sending error information may be different from each other. In this case, association of vehicle information with error information is performed based on detected time information and a vehicle ID. The server device 10 analyzes pieces of vehicle information on vehicles in which the same error has occurred to identify an information element common to the vehicles in which the error has occurred among the plurality of information elements contained in each piece of the vehicle information, and distributes a correction file over the air (OTA) to the in-vehicle terminal devices 12 of a vehicle group having the identified information element. Thus, users are able to resolve the error without bringing the vehicles 11 to repair shops, or the like. In addition, distribution cost is reduced by narrowing targets to be distributed based on vehicle information.

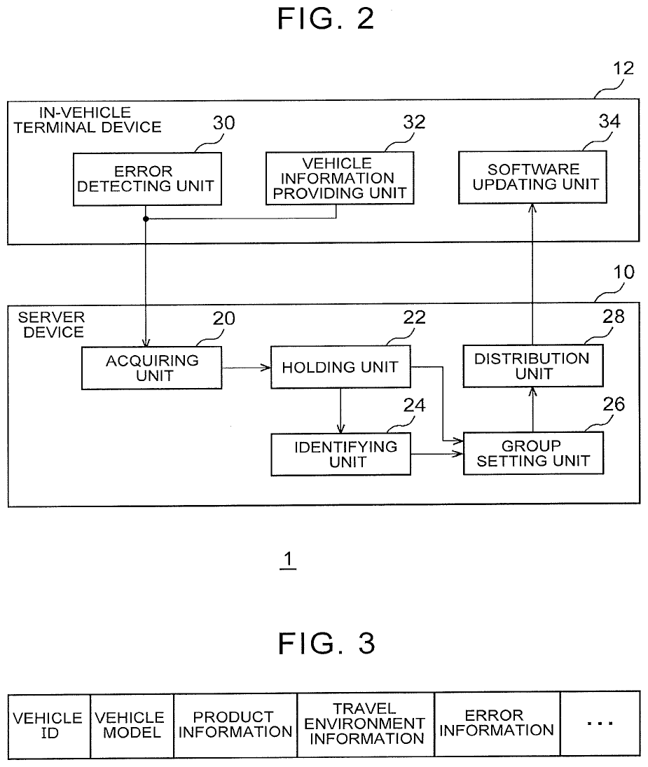

FIG. 2 is a diagram for illustrating the functional configuration of the software distribution system 1. In FIG. 2, elements shown as functional blocks that execute various processes may be made up of circuit blocks, a memory, and other LSIs in hardware aspect and are implemented by programs, or the like, loaded on the memory in software aspect. Therefore, persons skilled in the art understand that these functional blocks can be implemented in various forms by hardware only, software only, or a combination of hardware and software, and the functional blocks are not limited to any one of them.

The server device 10 includes an acquiring unit 20, a holding unit 22, an identifying unit 24, a group setting unit 26, and a distribution unit 28. Each in-vehicle terminal device 12 includes an error detecting unit 30, a vehicle information providing unit 32, and a software updating unit 34.

The error detecting unit 30 of the in-vehicle terminal device 12 detects an error in an in-vehicle software component and sends a detected result to the acquiring unit 20 of the server device 10 as error information. An in-vehicle software component is used to operate any one of the electronic control devices mounted on a vehicle and installed in the any one of the electronic control devices.

Error information includes information that indicates that no sound is output during operation of an audio or radio, information that indicates that display freeze has occurred during operation of a video reproducing function or navigation function, information that indicates that a display screen of a predetermined function of a display is not switchable, information that an interrupt notification to be displayed on the display is not displayed, and other information. Error information that is sent from the in-vehicle terminal device 12 may be an error number associated with an error. Error information detected by the error detecting unit 30 is sent to the acquiring unit 20 of the server device 10.

The vehicle information providing unit 32 provides vehicle information to the server device 10. Vehicle information contains information elements such as vehicle model, product information indicating the presence or absence and type of each of installed electronic control devices and in-vehicle software components, and information that indicates a travel environment of a vehicle.

The software updating unit 34 runs a correction file for correcting an error in an in-vehicle software component, distributed from the server device 10, to update the in-vehicle software component. A correction file may be configured to partially rewrite a program of an in-vehicle software component or may be configured to replace the entire program of an in-vehicle software component.

The acquiring unit 20 of the server device 10 acquires vehicle information and error information from the in-vehicle terminal devices 12 together with vehicle IDs. The holding unit 22 holds vehicle information and error information for each vehicle ID. In other words, the holding unit 22 holds error information in association with vehicle information.

FIG. 3 is a view that shows information that is held in the holding unit 22. Information that is held in the holding unit 22 contains vehicle ID, vehicle model information, product information of electronic control devices and in-vehicle software components, travel environment information, and error information. Vehicle model information, product information of electronic control devices and in-vehicle software components, and travel environment information are vehicle information. Vehicle information and error information are held in association with each other. Travel environment information is dynamically sent at predetermined intervals. Error information is sent when an error has been detected. On the other hand, vehicle model information and product information of electronic control devices and in-vehicle software components are held in advance at the time of entry into the holding unit 22, and version information of the in-vehicle software components is held at the time of update.

Referring back to FIG. 2, the identifying unit 24 identifies the information element common to a plurality of pieces of vehicle information associated with the same error information acquired from a plurality of the in-vehicle terminal devices 12. The identifying unit 24 compares pieces of vehicle information when there occurs an error and identifies vehicles in which it is estimated that the same error is occurring by extracting the common information element of vehicle information. Thus, targets to which a correction file for correcting an error can be accurately identified.

An identified result of the identifying unit 24 may be checked by a mechanic, and the distribution unit 28 may distribute a correction file after the mechanic completes checking. In other words, the distribution unit 28 may be configured not to distribute a correction file when a mechanic does not approve an identified result of the identifying unit 24. To check whether it is correct that the information element of vehicle information, identified by the identifying unit 24, is a factor causing the error, the identifying unit 24 outputs the identified result to show the identified result to a mechanic, the mechanic checks the identified result by experiment, or the like, and inputs, to the server device 10, whether the identified result of the identifying unit 24 is correct. By using the identified result of the identifying unit 24, the mechanic is able to easily identify a vehicle in which an error is occurring.

For example, when error information that a display image showing an area around a vehicle during parking assist does not switch to other display, such as navigation display, even when the parking assist ends at the completion of parking has been acquired from a plurality of vehicles, the identifying unit 24 identifies the information element of vehicle information, common to the plurality of vehicles in which an error has occurred. The identifying unit 24 compares pieces of vehicle information of the plurality of vehicles in which the error related to parking assist has occurred, and identifies installed corner sensors as the common information element of vehicle information as a factor causing the error. In this way, the presence or absence of an error can depend on the presence or absence of any one of in-vehicle devices.

Incidentally, there can be a case where a factor causing an error is actually due to the presence or absence of installed corner sensors, a plurality of information elements of vehicle information is common to a plurality of vehicles in which the error has occurred, and the information elements cannot be narrowed. When a plurality of information elements of vehicle information is common to a plurality of vehicles in which the error has occurred, the identifying unit 24 may narrow the information elements that are factors causing the error by using the vehicle information of vehicles that have not sent error information. Vehicles whose frequency of travel is high like vehicles traveling almost every day are selected as vehicles that have not sent error information. The identifying unit 24 compares a plurality of information elements of vehicle information, common to a plurality of vehicles in which an error has occurred, with information elements of vehicle information of vehicles that have not sent error information, and narrows the information elements by excluding information elements common to the information elements of the vehicles in which the error has occurred and the information elements of vehicles that have not sent error information

For example, when error information that a sound for audio is not output from a speaker has been acquired from a plurality of vehicles, the identifying unit 24 compares pieces of vehicle information of the plurality of vehicles that have sent the error information and identifies the common information elements of the vehicle information as information elements of which a manufacturer of an audio amplifier is common. In this way, the presence or absence of an error can depend on the type of a manufacturer of an in-vehicle device.

For example, error information that the navigation function, or the like, is reset in the case where infrastructure information is displayed on the display by interrupt, the identifying unit 24 compares pieces of vehicle information of the plurality of vehicles that have sent the error information, identifies that the error information has been sent from the vehicles that have travelled in a predetermined region, and identifies the positions of the vehicles as the common information elements of the vehicle information. For example, there are many interrupt communications of infrastructure information for vehicles that travel in an urban area, so there is a possibility that a processing load increases to cause an error. When error information is sent from vehicles that travel in a cold area, the identifying unit 24 identifies the positions of the vehicles as the information elements of the vehicle information, for example, when travel environments of the vehicles are lower than or equal to a predetermined outside air temperature. In this way, the presence or absence of an error can depend on the travel environment of a vehicle.

The group setting unit 26 receives the information element of vehicle information, identified by the identifying unit 24, consults vehicle information held in the holding unit 22, extracts vehicles having the same information element as the identified information element, and sets the extracted vehicle group for targets to which a correction file is distributed. For example, the group setting unit 26 uses the identified result of the identifying unit 24 to set a vehicle group equipped with a predetermined electronic control device for targets to be distributed, set a vehicle group with a common manufacturer of a predetermined electronic control device for targets to be distributed, or set a vehicle group that travel in a predetermined region for targets to be distributed.

When an error has been occurring in a predetermined region, the group setting unit 26 sets vehicles that have travelled in the predetermined region in the past for targets to which a correction file is distributed. The group setting unit 26 may set targets, to which a correction file is distributed, in a stepwise manner. When an error has been occurring in a predetermined region, the group setting unit 26 may set a vehicle group in order in which a traveling region of a vehicle is close to the predetermined region.

The distribution unit 28 distributes a correction file for correcting an error in an in-vehicle software component to a vehicle group having identified vehicle information. In this way, by narrowing a destination to which a correction file is distributed, a correction file is efficiently distributed and cost is reduced as compared to when a correction file is distributed to all the vehicles.

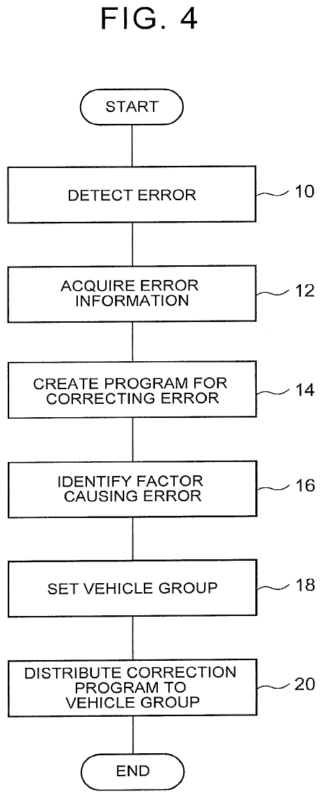

FIG. 4 is a flowchart of a software distribution process. The error detecting unit 30 of the in-vehicle terminal device 12 detects an error in an in-vehicle software component and sends a detected result to the acquiring unit 20 of the server device 10 as error information (S10).

The acquiring unit 20 acquires error information of in-vehicle software components from a plurality of vehicles (S12) An administrator of the software distribution system 1 creates a correction file for correcting the error in the in-vehicle software components (S14). The identifying unit 24 identifies an information element of vehicle information, common to the same error information acquired from the plurality of in-vehicle terminal devices 12, as a factor causing the error (S16).

The group setting unit 26 receives the information element of the vehicle information, identified by the identifying unit 24, consults vehicle information held in the holding unit 22, extracts vehicles having the same information element as the identified information element, and sets the plurality of extracted vehicles for targets to which the correction file is distributed as a vehicle group (S18). The distribution unit 28 distributes the correction file for correcting the error in the in-vehicle software component to the vehicle group having the identified vehicle information (S20). The software updating unit 34 of the in-vehicle terminal device 12 runs the correction file distributed from the server device 10, and updates the in-vehicle software component.

The embodiment is only illustrative. Various modifications are possible through combinations of components. Persons skilled in the art understand that the scope of the disclosure also encompasses such modifications.

What is claimed is:

1. A software distribution system comprising:
an acquiring unit configured to acquire, from vehicles, error information about an in-vehicle software component having an error;
a holding unit configured to hold acquired error information in association with vehicle information of the vehicle from which the error information is acquired;
an identifying unit configured to identify an information element common to a plurality of pieces of vehicle information associated with the same error information; and
a distribution unit configured to distribute a correction file for correcting the error in the in-vehicle software component to a vehicle group having the identified information element.

2. The software distribution system according to claim 1, further comprising a group setting unit configured to set the vehicle group having the information element identified by the identifying unit to a destination to which the correction file for correcting the error in the in-vehicle software component is distributed.

3. The software distribution system according to claim 1, wherein:
each piece of the vehicle information contains travel environment information of the associated vehicle when there occurs the error in the in-vehicle software component as the information element; and
the identifying unit is configured to identify the information element common to the same error information based on pieces of travel environment information of a plurality of the vehicles that have sent the error information.

4. A software distribution method comprising:
a step of acquiring, from vehicles, error information about an in-vehicle software component having an error;
a step of holding acquired error information in association with vehicle information of the vehicle from which the error information is acquired;
a step of identifying an information element common to a plurality of pieces of vehicle information associated with the same error information; and
a step of distributing a correction file for correcting the error in the in-vehicle software component to a vehicle group having the identified information element.
